(19) United States
(12) Patent Application Publication
(10) Pub. No.: US 2003/0030750 A1
(43) Pub. Date: Feb. 13, 2003

(54) System and method for data distribution network

(76) Inventors: William Leo Hoarty, Morgan Hill, CA (US); Bruce David Nilo, Cupertino, CA (US); Kenneth Eliot Kofman, Sunnyvale, CA (US)

Correspondence Address: John S. Pratt, Esq., KILPATRICK STOCKTON LLP, Suite 2800, 1100 Peachtree Street, Atlanta, GA, 30309, US

(21) Appl. No.: 09/928,592

(22) Filed: Aug. 13, 2001

(51) Int. Cl. H04N 7/20; H04N 7/16; H04N 7/00; H04N 11/00

(52) U.S. Cl. 348/461; 348/468; 725/136; 725/135

(57) ABSTRACT

Methods and systems for broadcasting data over a television signal spectrum. A network center receives rich media content elements from content providers. The network center aggregates and bundles the content elements and transmits a bundled content element to a wide network delivery system. The wide network delivery system in turn transfers the bundled content elements to a local broadcasting station associated with a local market. The local broadcasting station includes an edge server for storing content elements intended for the local market. At specified time, a new local content element is provided by the edge server to a signal combiner. The signal combiner inserts the new local content element into the television signal spectrum associated with the local broadcasting station. A transmission facility broadcasts simultaneously a signal related to the new local content element and a convention television signal. A receiver receives the television signal spectrum containing the inserted signal and extracts the new local content element from the spectrum.

This application relates to a patent application Ser. No. US09/06225, filed Apr. 17, 1998, and a patent application Ser. No. PCT/US99/08513, filed Apr. 16, 1999, which are owned by the assignee of this application and are incorporated in its entirety by this reference.

### TECHNICAL FIELD

This invention relates to providing a vast amount of data to consumers of information and entertainment, and, in particular, to networks and methods for delivering information and effectuating an information shelf in business centers and homes of information and entertainment consumers.

### BACKGROUND OF THE INVENTION

The advent of the digital age made it possible for information and data exchange that had not been thought possible only a decade ago. For example, via the Internet, global communication and exchange of information are possible today. However, the conventional digital infrastructure lacks the capacity to deliver rich-media content or, for that matter, any digital content which is typically large in file size. For example, the bandwidth of the Internet is plagued by various delays associated with modems, routers, and servers. The Internet was not designed to deliver rich media on a large scale and in real time. The very backbone structure of the Internet, a web of paths linking routers and servers which serve as nodes but also as chokepoints, limits the network's performance in delivery of streaming data. As a simple example, downloading a CD-quality album via the Internet employing either a DSL or a cable modem takes fifty-five (55) and sixty-five (65) minutes, respectively. For dial-up modems, it takes between six (6) to eight (8) hours to download a 60-minute CD.

At the present, the availability of video, music, games, software and other forms of rich media is growing faster than the bandwidth of the conventional network. Furthermore, the user population is also growing fast, with each new user placing an independent demand on the network. There is a need for a data distribution network capable of delivering rich media and voluminous content without the delay associated with the conventional network.

Currently, there are a limited number of paths or connections into an information consumer's home or business; these include telephony connections, power connections, cable television connections, satellite downlink, radio spectrum and television spectrum. Interactive content is generally delivered for consumption on computer devices via telephony and cable connections. However, recent developments have brought about delivery of interactive television content via satellite downlink, with an upstream link to the source via Internet or switched telephone network over telephony or cable physical links. There is a need for infrastructure to deliver rich media and voluminous content the so-called “last mile” over the existing broadcast television spectrum, which to date has not been leveraged successfully for this purpose, but which contains capacity for conveyance of substantial information. In the same vein, there is a need for interactivity in such delivery systems, via whatever upstream medium or mode, including telephony or cable connections.

Cost and scarcity of satellite transponders, combined with their suitability optimized distribution of content in a broadcast architecture over an expansive geographic area, renders it difficult to justify delivery of movies, music and other content on demand to particular users over the large footprint. There is therefore a need for an architecture which leverages satellite/radio frequency distribution of content to edge servers or platforms, which can then service smaller geographic areas and sets of users for more responsive and efficient distribution of content interactively or on demand.

### SUMMARY OF THE INVENTION

The present invention delivers an ultra-high-speed, high-quality distribution of rich-media and other large-sized assets. The present invention comprises a broadband digital content distribution network. The delivery of rich media is accomplished through the existing television distribution infrastructure, including the structures built in accordance to the standards specified by the National Television Systems Committee (NTSC) and for the Advanced Television Systems Committee (ATSC), as well as international standards of Phase Alternating Line (PAL), and Digital Video Broadcasting (DVB) systems.

An exemplary network of the present invention includes four major components: a network center, a wide network delivery system, a local broadcasting station, such as a local television station, and a receiving device located at the home or the business center of an end customer. A network center receives content elements from various content providers, aggregates the content elements and creates a bundled content element for delivery. The network center also transmits the bundled content element to a wide network delivery system, such as a satellite transponder. The transponder in turn transmits or relays the bundled content to numerous intermediary local broadcasting facilities.

Each local broadcasting station is associated with a local market. Each local broadcasting station includes devices, such as a satellite dish, for receiving a portion or the whole of the bundled content element from the wide network delivery system. The content intended for the local market and newly received from the wide network delivery system is defined as the new local content element and is stored in an edge server associated with the local broadcasting station. The local content elements that are accumulated and stored in an edge server over a period of time is defined as the accumulated local content element.

In one embodiment, at a specified time, such as a request by a consumer to view a particular movie, the edge server provides the new local content element to suitable encoding, combining, directing, multiplexing, converting or processing functionality (hereinafter “signal combiner”) that inserts a signal related to the new local content element into the television signal spectrum associated with the local broadcasting station. The scheduling of the release time for the new local content element can be determined and specified by a content manager associated with the network center.

In another embodiment, the local broadcasting station utilizes an internal scheduling system which provides a schedule to time and meter the transmission of content from the edge server to a receiving device. The schedule can be supplied to the scheduling system remotely, for example, from the network center, or locally within the broadcasting station. The receiving device is typically located in an end-customer's home and stores the received content in a hard disk drive for later use by the end customer. For example, movies on demand or other content such as music videos, video games, software applications can be stored at the edge server located in the local broadcasting system then be released at a scheduled time and become stored at the receiving device of an end customer. Similarly, financial and other information can be delivered at scheduled time to businesses with a receiving device for use in an office or to commercial establishments having such devices as interactive information kiosks.

The television signal spectrum containing the inserted signal related to the new local content element is transmitted by a transmission facility associated with the local broadcasting station. The transmission facility, which can be conventional, transmits simultaneously both the inserted signal and a conventional television signal. According to the principles of a related patent application, PCT/US Ser. No. 99/08513 filed Apr. 16, 1999, titled “Expanded Information Capacity for Existing Communication Transmission Systems,” which is incorporated herein by this reference, conventional television signals are received without adversely being affected by the presence of the inserted signal in its spectrum. Similarly, the inserted signal is also received without adversely being affected by the presence of the television signal in its carrier spectrum.

A receiving device located in the homes or business centers of end customers receives the television signal spectrum containing the inserted signal and extracts the data from the spectrum. The receiving device stores the extracted data in a hard drive or other mass media storage for the consumption thereof by the end-consumer. Examples of local content elements include, among other things, full-length feature films, personalized jukeboxes, video game arcades, software applications, electronic books and educational materials. The present invention provides a network for effectuating information shelves at the homes and business centers of end-consumers.

The receiving device can also include a communication port for communicating with the network center via a back channel. An example of the back channel is the Internet. Via the back channel, the receiving device communicates if a critical block, for example the header or a block containing control information is received corrupted. The network center determines if retransmission of the critical block is advisable. Upon its determination, the network center sends a request to the edge server servicing the receiving device to retransmit the critical block. In response, the edge server re-provides the critical block to the signal combiner for re-broadcasting of the critical block. The network of the present invention assures a high quality transmission of rich media. The back channel can obviously be used for other purposes, including interacting with the system to order movies or other content, or otherwise to affect what is being delivered, when and how to the consumer. The back channel can be considered analogous in many ways, including purposes and uses, to the upstream connection to the Internet that is currently available to most browsers connected to the Internet via telephony or cable connections.

Furthermore, the receiving device can include a communication port for communicating with various wired and wireless devices via a home network. A home network comprises a communication link that delivers home information. Examples of home information include, among other things, telephone messages, utility billing information, local news, local entertainment schedules, stock quotes, notes that family members create for other members, as well as content elements received and stored by the receiving device via the data distribution network of the present invention and the back channel.

The digitized rich media delivered via the network of the present invention are preferably but not necessarily formatted according to the standards specified by the Moving Picture Experts Group (MPEG), and more preferably to the specifications of the MPEG2. However, for certain critical data, more error protection is provided than that specified in the MPEG2 specifications. The reason is that the nominal error rate of MPEG2, which is 10⁻⁸, is insignificant if the output is video data, but can result in noticeably adverse consequences if the error bits occur in the headers or blocks containing control information. Accordingly, the present invention can provide additional software error protection for the header and control blocks embedded in the data transmitted by the network of the present invention.

At the time of shipment to a sales point, a receiving device can be loaded with information available for an average local market. Because the delay involved between the shipment and purchase of the receiving device, the pre-installed information is likely to be out of date when an end-customer brings it to his home or business center. That is, new releases of digitized rich media have occurred in the market. Furthermore, because the characteristics of the local market associated with the geographical area in which the receiving device becomes installed may differ from the characteristics of the average local market, in general, the receiver device needs to be synchronized when it becomes installed in the home or business center of an end-customer.

The synchronization of new devices, or of old devices that might have been re-plugged in after a period of hiatus is achieved by broadcasting the content available for a given local market at a slow rate. The edge server, when it is not releasing the new local content element, cycles through the accumulated local content element, which is defined as the local content elements accumulated and stored in the edge server over a period of time, and causes the signal combiner to insert a signal relating to the accumulated local content element into the television signal spectrum of the corresponding local station. The present invention provides systems and processes for synchronizing receiving devices located throughout the wide data distribution network of the present invention.

In addition to the functions discussed hereto, the network center also aggregates advertisement for content elements provided by the content provider. For example, the network center prepares and provides a digitized preview for an upcoming movie release. The network center also provides for billing and customer support.

### BRIEF DESCRIPTION OF THE DRAWINGS

FIG. 1 is a schematic overview of an exemplary network according to one embodiment of the present invention.

FIG. 2 is a block diagram of an exemplary network center according to one embodiment of the present invention.

FIG. 3 is a block diagram of an exemplary local transmission facility according to one embodiment of the present invention.

FIG. 4 is a block diagram illustrating an exemplary environment for an exemplary receiving device according to one embodiment of the present invention.

### DETAILED DESCRIPTION OF THE INVENTION

An Overview of an Exemplary Network

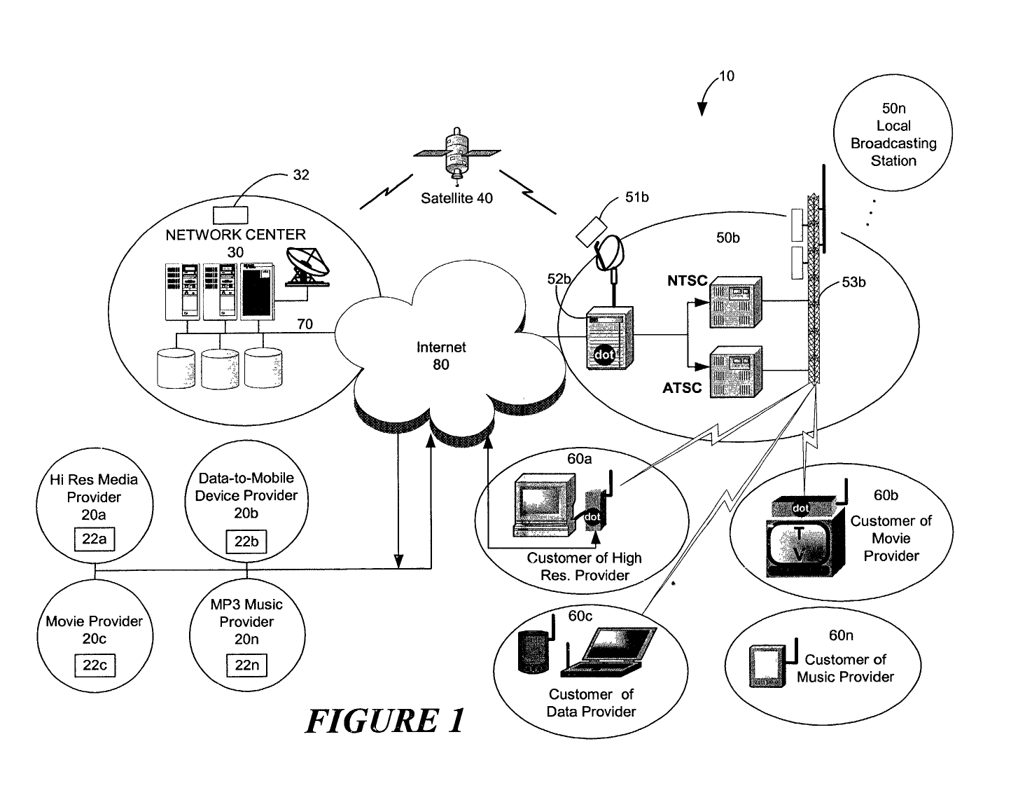

FIG. 1 illustrates an overview of an exemplary network 10 according to a preferred embodiment of the present invention. Content providers, commonly designated as 20, deliver content elements, commonly designated as 22, to a network center 30. FIG. 1 illustrates examples of content providers, such as a high resolution media provider 22a, a data provider 22b, a movie provider 22c and a music provider 22n.

A network center 30 aggregates content elements received from the content providers 22a through 22n and appropriately bundles them into a bundled content element 32. The network center 30 transmits the bundled content element 32 to a wide network delivery system, such as a satellite 40. The network center 30 provides also a variety services for the content providers, including, among other things, sales support, content management, billing and advertisements.

The wide network delivery system in turn transmits the bundled content element 32 to a plurality of local broadcasting stations, commonly designated as 50. Each local broadcasting station receives either a portion or the whole of the bundled content element 32 from the satellite 40. As an example, the local broadcasting station 50b receives a new local content element 51b intended for the local market associated with the broadcasting station 50b. The new local content element 51b is stored in an edge server 52b until the release time typically scheduled by the network center.

At the release time for the new local content element 51, the edge server 52b provides the new local content element 51b to a signal combiner so that the new local content element 51b can be inserted in the television signal spectrum associated with the local broadcasting station 50b. A local transmission facility 53b associated with the local broadcasting station 50b transmits simultaneously a signal related to the new local content element 51b and a convention television signal.

A plurality of receiving devices, commonly designated as 60, receives the local content element 51b broadcast by the local broadcasting station 50b. An end customer may be receiving high resolution media provided by the provider 22a via his receiving device 60a. Another end customer may be receiving information from the data provider 22b via her receiving device 60c, which can be a mobile device enabled to receive information from the distribution network of the present invention. Yet another end customer may be receiving movies from the movie provider 22c via her receiving device 60b, which can be a movies-on-demand player enabled to receive information from the distribution network of the present invention. Still another end customer may be receiving music from the music provider via his receiving device 60n, which can be an audio device enabled to receive information from the distribution network of the present invention.

Regardless of the content being received, a receiving device such as 60a receives the television signal spectrum containing the inserted signal related to the new local content element 51b and extracts the new local content element from the television signal spectrum. Depending on the subscription arrangement that the end customer has arranged with the network center, either a portion or the whole of the new local content element 51b is stored in the hard drive of the receiving device 60a and becomes available to the end-customer. Accordingly, the present invention provides a wide data distribution network using the existing infrastructure for the distribution of conventional television signals.

The network of the present invention can also include a back channel 70 for allowing communication between the various components illustrated in FIG. 1. The Internet 80 is illustrated as the back channel in FIG. 1, however any communicational link, including the PSTN, may be used for the back channel 70. In addition, although satellite 40 is used to illustrate the wide network delivery system, those skilled in the art will understand any wide network delivery system such as fiber optics, may be used in the place of the satellite.

The content providers include, among others, conventional television program makers, cable program providers, movie, music, video, electronic book makers and any other kinds of information service providers, such providers of financial, corporate, sports and general news, and providers of distance learning and interactive learning programs, as well as makers and providers of general and targeted advertisement. Examples of the content elements 22a through 22n include, among other things, television programs, movies, including full-length feature films as well as short videos, music, personalized jukeboxes, video games, software applications, educational materials, financial and corporate materials, e-commerce and interactive advertising materials, and a “best of the web” assortment of the most-visited websites.

Network Center

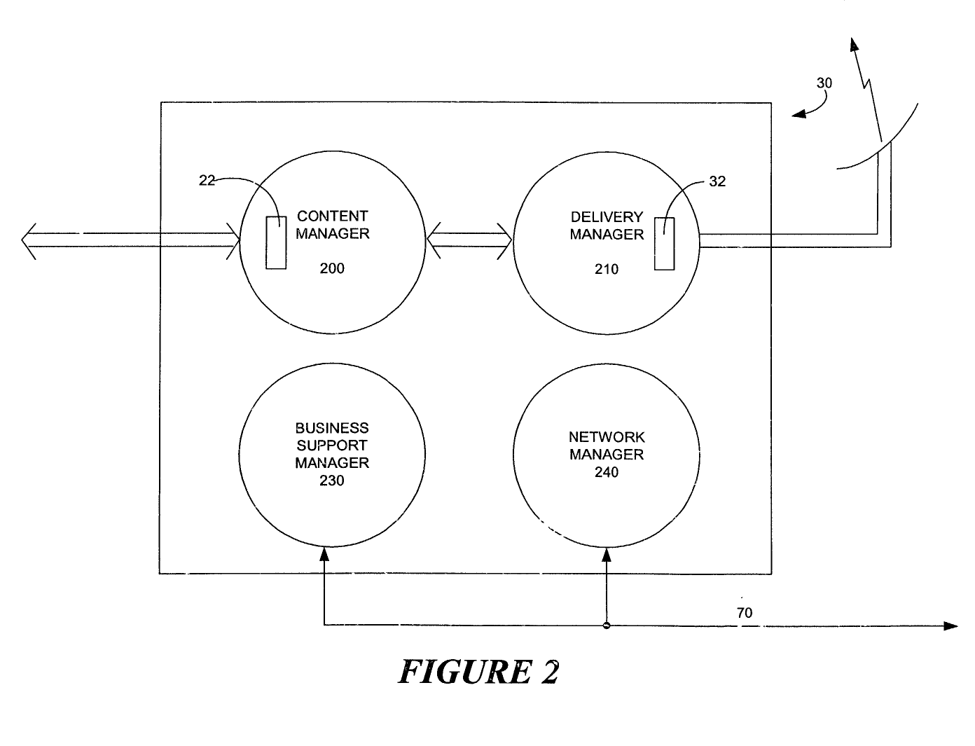

The network center 30 provides a broad range of content management for the makers and owners of rich media, including aggregating content elements, causing delivery of content elements to end customers, customer support, and processing transactional services. Referring to FIG. 2, an exemplary embodiment of the network server 30 includes four major components. A content manager 200 receives content elements from various content providers. The content providers move their content elements in a similar way they move their assets to any Web-hosting service, for example, via virtual private networks, fiber optic networks, videotapes, and satellite networks. The content providers may provide their content assets in any form although, in general, the content assets are delivered from the content providers in a digitized form. The content manger 200 aggregates the content elements from various content providers and bundles the content elements into the protocols specified by the Moving Picture Experts Group (MPEG), and in particular, to the MPEG2 transport stream specification. The content manager also prepares promotional materials targeted for varying markets of end customers. In addition, the content manager 20 determines release schedules for the various content elements and specifies a release time table for each content element. The content manager also performs an archiving function.

The content manager 20 also provides each content element with a default time period during which the end customer is allowed to utilize the content element. For example, a content element received by the receiving device 60a may be specified to be available for a month. The content element then becomes unavailable to the end customer after the month of time. If the end customer wishes to use a particular content element for a longer period than the default period, the customer contacts the network center to obtain the right to use the content for the additional time. Furthermore, the default time period for the content elements may vary according to the market condition. For example, the default time period for a very popular movie may be longer then an unpopular movie.

Furthermore, the content managers support third-party, digital rights management (“DMR”) services to help the content providers protect their copyright materials. Such services encrypt content and include usage rights, business rules and duration of usage. For instance, for a movie service, the DRM system can allow a user to watch a movie for a twenty-four (24) hour period. The user would be charges a fee for the usage. A second viewing on a subsequent date can be allowed for a reduced fee. In the case of music, the DRM system can provide a variety methods for compensating the owners of copyrighted materials, such as, among other things, pay-per-play and pay-to-own.

A distribution manager 210 distributes the bundled content elements to a wide-network delivery system. As an example, the distribution manager 210 uplinks the bundled content element 32 to the satellite 40. However, those skilled in the art will understand any wide network delivery system can be used in the place of the satellite. The advantage of using a wide-network delivery system, such as a satellite, is that the content is now made possible for broadcast over a large geographical area that covers, for example, every U.S. market place. In addition to avoiding the bandwidth problem of the Internet, a wide-network delivery system, such as the satellite, also makes possible delivery of targeted information to a specific local market.

A business support manager 230 provides a twenty-four (24) hours a day and seven (7) days a week customer care. It handles provisioning of services, billing, transaction processing, and other services for the content providers, local distributors, and end customers. The business support manager 230 uses a back channel, such as the Internet, to communicate with and provide services to various users of the present invention.

A network manger 240 assures high quality service standards. For example, it remotely monitors all devices on the network of the present invention. As an example, the network center can monitor the quality of data transmission via the back channel. The network manager 240 uses a back channel, such as the Internet, to communicate with and provide high quality services to various users of the present invention. The back channel is also used to transfer time-sensitive information, such as a personal message that needs to be delivered within an hour or minute, to various components on the network of the present invention.

Local Broadcasting Station

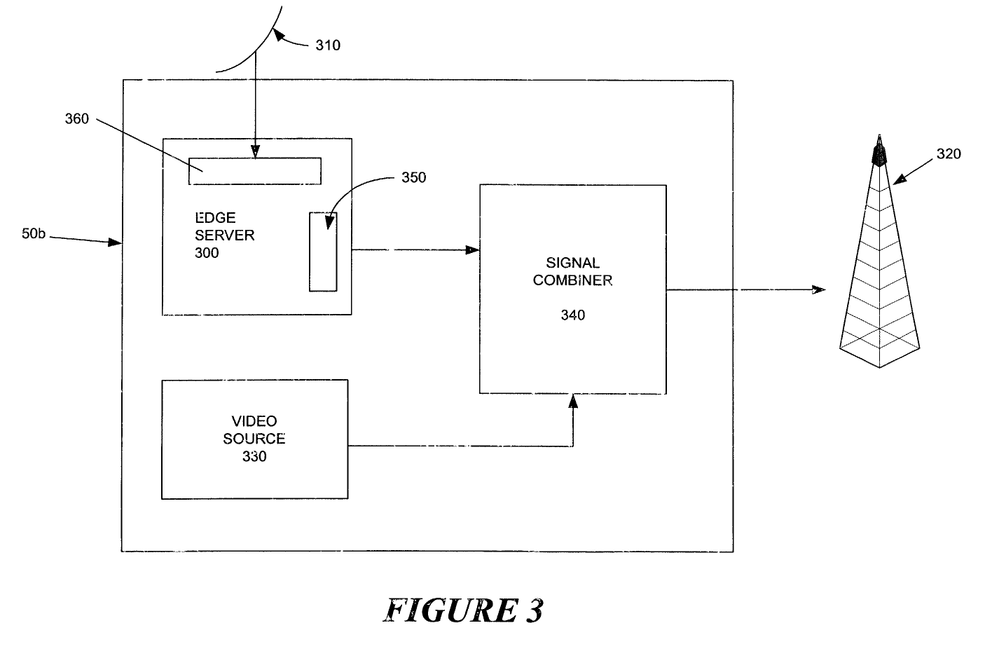

Referring to FIG. 3, an exemplary embodiment of the local broadcasting station, a local television station 50b, includes an edge server 300 in addition to a receiver 310, a transmission facility 320, and a conventional video source 330. The receiver 310 receives either a portion or the whole of the bundled content element 32. That is, depending on the characteristics of the local market associated with the television station 50b, the content manager 200 determines the content elements to be delivered to the local market and marks only a portion of the bundled content element 32 as intended for the local market. Accordingly, the present invention allows for targeted distribution of rich media.

The edge server 300 stores the bundled content element 32 intended for the local market and is received by the receiver 310. The newly arrived and stored content element shown as 360 in FIG. 3 is defined as the new local content element. The new local content element 360 is associated with a release time. The content manager 200 either marks the release time at the time it aggregates and bundles various content elements received from content providers, or the content manager 200 communicates with the edge server 300 via the back channel 70 and indicates to the edge server 300 the release time for the new local content element 360.

When the release time arrives, the edge server 300 provides the new local content element 360 to a signal combiner 340. The signal combiner 340 can be any processing, encoding, directing, multiplexing, piping, or combining functionality that allows information from one source and information from another source to be transmitted simultaneously. In response to the provisioning of the new local content element 360, the signal combiner inserts signals related to the new local content element 360 into the television signal spectrum associated with the local television station 50b. The technology related to providing data within the spectrum of a conventional television signal is a subject matter of the related patent application Ser. No. PCT/US 99/08513 and is disclosed herein by reference. Most importantly, through the use of an abatement signal, both data signals and conventional television signals are received at their respective receiving devices without being adversely affected by the multiplexing of two different types of information carrying signals.

The transmission facility 320 broadcasts the television signal spectrum containing the inserted signals related to the new local content element 360. That is, conventional television signals from, for example, a video source 330 are transmitted simultaneously with signals related to the new local content element 360 provided by the edge server 300. In accordance with the principles of the related patent application Ser. No. PCT/US 99/08513, the present invention is capable of delivering 4.5 million bits per second within any conventional NTSC or PAL television signal spectrum. As a contrast with the Internet, downloading a CD-quality album via the network of the present invention takes less than three (3) minutes. In addition, the throughput of the network of the present system increases up to (ten) 10 million bits per second if the local television station comprises a conventional digital television signal bandwidth.

FIG. 3 illustrates a video source that provides the conventional television signals with which the data signals relating to the new content element are multiplexed. Those skilled in the art will understand an audio source can also be used in the place of the video source 330 shown in FIG. 3.

When the edge server 300 is not effectuating delivery of a new local content element, it provides an accumulated local content element 350 to the signal combiner 340. An accumulated content element 350 includes local content elements that have been released over-the-air during a given period of time. For example, if one hundred (100) movies have been delivered to the local market between time X and time Y, the edge server cycles through and provides the one hundred (100) movies to the signal combiner. In response, the signal combiner 340 inserts signals related to the accumulated local content element 350 into the television signal spectrum associated with the television station 50b and causes the transmission facility 320 to broadcast the accumulated content element 350. For example, the transmission facility 320 broadcasts a cycle of one hundred (100) movies when it is not broadcasting a new local content element.

If at time Z, a new local content element becomes available for release, the edge server 300 causes the broadcast of the new local content element, instead of the accumulated local content element. After its release, the new local content element replaces the oldest content element that comprises the accumulated local content element 350, unless otherwise specified by the content manger 200 or the network manger 240. In other words, each local content element comprising the accumulated local content element 350 is associated with a timestamp. When time passes and a new local content element is released at time Z, the content element having the oldest timestamp is replaced by the new local content element, unless otherwise specified by the content manger 200 or the network manager 240. For example, the content manager 200 may have indicated a longer default period for a content element that was received at a time A than another content element that was received at a later time B. In such a case, the new local content element arriving at time Z may replace the content element received at time B. As another example, the end customer may have contacted the network center and requested for an additional period for a particular content element. In such a case, the new local content element arriving at time Z may not replace the particular content element although it may be the oldest among the content elements comprising the accumulated local content element. The present invention provides various ways to control and manage rich media for the content providers and the benefit of the end customers.

The continuous broadcast of the accumulated local content element 350 allows for synchronization of receiving devices located in the local market associated with the local television station 50b. The synchronization process of a receiving device is discussed hereinafter.

Another exemplary embodiment of the present invention employs two local broadcasting stations and two transmission facilities per local market. The use of at least two transmission facilities increases diversity of rich media available in a local market and increases reliability and fault-tolerance of the network of the present invention.

The advantage of the present invention includes the use of the existing television distribution infrastructure. For example, only in the U.S. market, the network of the present invention has about 1600 transmission facilities available to broadcast digitalized rich media. Thus, the infrastructure investment is far less than with cable modems and xDSL. Data is, for the most part, distributed over an existing network. Furthermore, virtually every American home and business center can receive an over-the-air television signal. Thus, the present invention provides a ready market of about 250 million people. The present invention provides compatibility between the analog and digital broadcast worlds. Accordingly, the present invention facilitates smooth transition from an analog broadcast world to a digital broadcast world.

Receiving Device

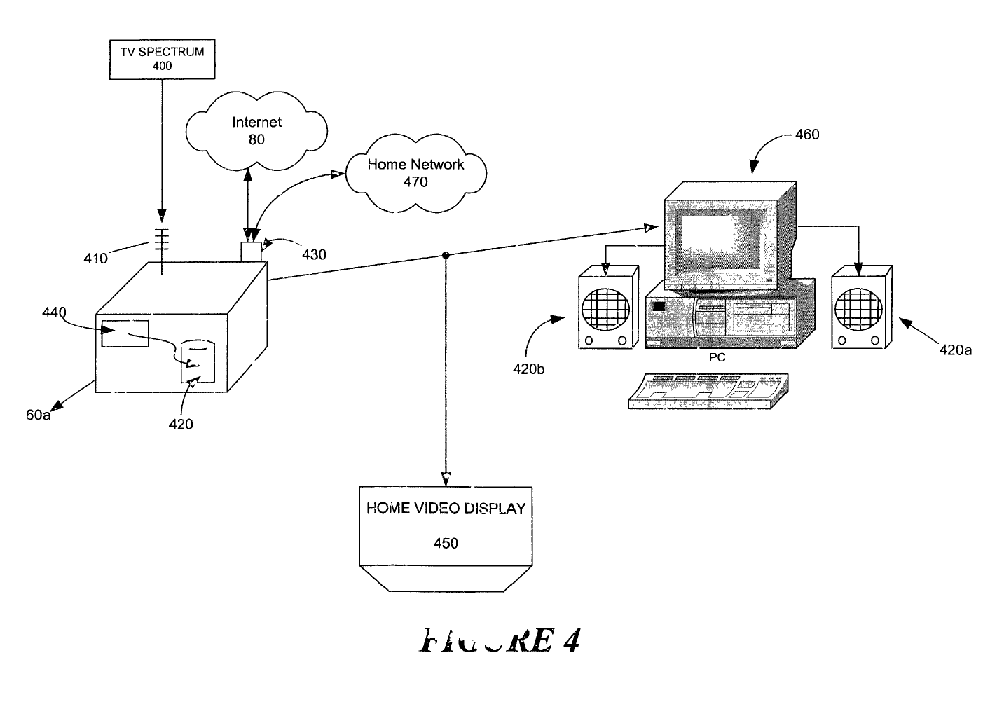

Referring to FIG. 4, an exemplary embodiment of the receiving device 60a includes an antenna 410, a hard drive 420, and a communication port 430 for communicating with the network center 30 via the back channel 70. The receiving device 60a can also communicate with a home network 470 via the communication port 430.

The receiving device 60a receives the television signal spectrum 400 inserted with signals related to the new local content element 360 or the accumulated local content element 350. The receiving device 60a then extracts a customer content element 440, to which the end customer subscribes. The technology for receiving a television signal spectrum inserted with signals and extracting the correct data is disclosed in a related patent application, US09/062225, filed Apr. 17, 1998, titled “Expanded Information Capacity for Existing Communication Transmission Systems,” which is incorporated herein by this reference.

The extracted customer content element 440 is stored in the hard drive 420 and becomes available for the end customer. The end customer of the present invention has ready rich media content at his finger tip at the convenience of his home or his business. For example, the end customer can watch DVD quality films via a video displayer 450, listen to CD quality music using the PC 460 and speakers, commonly designated as 420, or engage in distance learning and interactive use of information. The customer content element 440 may also be displayed and vocalized via an information kiosk located in a public place, such as a shopping mall or an airport. Other examples of the devices that may be utilized to view or listen to the customer content element 440 include, among others things, television set-top boxes, in-home entertainment systems, mobile devices, such as PDA's and MP3 players.

If the hard drive of the receiving device 60a is full when a new customer content element arrives, the new customer content element replaces the oldest customer content element stored in the hard drive, unless otherwise specified by the content manager 200 or the network manager 240. In other words, each customer content element stored in the hard drive of the receiving device 60a is associated with a timestamp. When a new customer content element arrives at the receiving device, the oldest customer content element is replaced, unless otherwise specified by the content manager 200 or the network manager 240. For example, if the end customer wishes that his receiving device retain a particular customer content element for a longer period than a default period, he contacts the network center for an arrangement that will fit his needs. In such a case, a newly arrived customer content element may not replace the oldest customer content element residing in the receiving device 60. As another example, if the content manager 200 has specified a longer default period for a particular customer content element, the newly arrived customer content element may not replace the particular customer content element, even though it may be the oldest residing in the hard drive of the receiving device 60. In addition, if a customer wishes to store a particular customer content element in a storage element, such as a CD-ROM, the customer contacts the network center to effectuate such a transfer of the particular customer content element.

The receiving device 60a also enables personalized capture of digitized rich media with user preference, collaborative filtering, and other smart digital assistances. Furthermore, the receiving device 60a supports all Digital Rights Management (DRM) systems simultaneously and includes a DRM router that automatically matches the content to its respected DRM.

In addition, the receiving device communicates with various wired and wireless devices via the home network 470. The home network 470 comprises a communication link that enables transfers of messages and information between various communication devices that the end customer owns or devices that deliver information to the end customer. As an example, the customer's bank service provider may delivers account information to the end customer via the home network 470. As another example, the receiving device may receive a personal note via the home network 470 from a wireless personal digital assistance (“PDA”) Data transferred on the home network 470 is defined as home information and includes, among other things, telephone messages, utility billing information, local news, local entertainment schedules, stock quotes, notes that a family member creates to communicate with other members, as well as content elements stored in the receiving device. Examples of wired device include a telephone, a video displayer, an audio player, and a personal computer. Examples of wireless device include a wireless telephone, a PDA, a Palm Pilot, communication devices available in traveling units such as cars and airplanes, and other handheld devices.

Furthermore, if a data block containing critical information is received corrupted, the receiving device 60a communicates with the network center via the back channel 70 and alerts the receipt of the bad block to the network center. FIG. 4 illustrates that the receiving device 60a includes a communicating functionality that allows the device to access the Internet 80.

The present invention provides an end-to-end wide data distribution network. The network of the present invention receives rich media from content providers and is able to provide streaming data to end customers using the existing television distribution infrastructure. Accordingly, the present invention allows the broadcast industry to enter the high-growth data delivery business using their existing NTSC infrastructure and provides a pathway to expanded services using the emerging digital television facilities.

An Exemplary Delivery Method

An end consumer buys a receiving device with a 100 gigabyte hard drive. The hard drive comes installed with information, for example, one hundred (100) movies that are available on the network of the present invention at the time of the shipment of the receiving device to a sales point. There is a delay between the shipment of an electronic device to the time when the device becomes installed in the home or business center of the end customer. Accordingly, when the end customer plugs in the newly purchased receiving device 60a, the information installed at the time of the shipment needs to be updated and synchronized to content elements available in the local market of the end customer.

The synchronization is achieved because the local transmission facility 320 continuously broadcasts the accumulated local content element at a slow rate. Synchronization becomes also necessary if a receiving device becomes re-installed after a duration of hiatus, such as when an end customer unplugs the receiving device when he leaves for a vacation and re-plugs it after his vacation.

An average film can be represented as eight hundred (800) to one thousand (1000) Mbytes of data. Thus, a receiving device with a gigabyte hard drive can store about one hundred (100) movies. In an exemplary embodiment, the network of the present invention delivers one hundred (100) movies per month and updates twenty-five (25) movies per week. In such an embodiment, the end customer has one hundred movies for his enjoyment at any month of the year.

When the network of the present invention releases twenty-five (25) movies for the new week, the new movies, replace, in general, the oldest twenty-five movies stored in the receiving devices of the end customers. However, the duration of the availability for any particular media content may be varied according to the demand of the market place, as well as the preference of the end customer. For example, the duration of a very popular movie may be longer than the default period of one month. As an another example, an end customer may contact the network center and request for an addition period for a fee.

At one thousand (1000) Mbytes per movie, the delivery of twenty-five (25) movies per week implies that the network of the present invention delivers one (100) Gbits per week. With a 4.5 Mbits per second throughput, the network of the present invention delivers twenty-five (25) movies in about 6.2 hours. When the network is not delivering a new release, the local television transmission facility broadcasts an accumulated local content element. In this example, the network delivers one hundred (100) movies in about three (3) to four (4) weeks of time.

Provisioning of Additional Error Correction Codes

The digitized rich media that is transferred between various components of the network of the present invention is preferably packaged according to the standards specified by the Moving Picture Experts Group (MPEG), and more preferably, to the specifications of the MPEG 2 transport stream. Accordingly, digitized rich media elements are provided for error correction in different layers of the multi-layered MPEG2 protocol. A preferred embodiment provides for error protection/correction capabilities at three different layers of the MPEG2 protocol. The lowest level, which comprises the MPEG2 transport stream, is protected by a Reed-Solomon or Turbo Product Code. Inside the MPEG transport, a data packet typically comprising 50,000 bytes is provided with a cyclic redundancy check (CRC) code to detect errors. Bad blocks are either repaired via the back channel by communications with a 1 bad-block correction server or by the receiver device listening to a rebroadcast of the content at a later time. At the third layer, an embedded forward error correction code around the content asset itself is provided.

In addition, in accordance with the MPEG2 specifications, the header and control information is provided with more error protection than the data payload. The MPEG2 specifies a 10⁻⁸ bit error rate. In an eight (8) gigabits of video data, the standard MPEG2 error rate will result in eighty (80) to one hundred (100) error bits. These error bits would be insignificant in a video output. However, if the error bits occur in the header or control blocks of a content element, a noticeably adverse effect would occur in the network of the present invention. For example, the receiver device 60a would be unable to correctly synchronize the incoming data. Accordingly, the present invention provides more error protection for the header and control blocks embedded within the digitized rich media transferred via the network of the present invention.

If a bad header or control block is received by the receiving device 60a, the device 60a communicates the receipt of the bad block via the back channel 70. The network manger 240 determines if a retransmission of the affected data block is advisable and upon its determination, it communicates with the edge server servicing the receiving device 60a via the back channel. As an example, the network manager 240 requests that the edge server causes a retransmission of the header that has not been correctly provided to the receiving device 60a. In response, the edge server 300 retransmits the particular block by inserting the block in an unused portion of the spectrum for television signals. The bad block can also be retransmitted via the back channel.

The present invention removes the congestion on the Internet by providing a cost-effective network via which rich media can be broadcast simultaneously to millions of receivers. The present invention includes a back channel, such as the Internet, that preserves the ability of consumers and businesses to conduct transactions, request additional information, or respond with regard to the information that has become available. Furthermore, because virtually every American household and business can receive an over-the-air television signal, the present invention delivers an immediate market potential of nearly 250 million people to content providers, as well as the ability to support a targeted marketing strategy.

Additional alternative embodiments will be apparent to those skilled in the art to which the present invention pertains without departing from its spirit and scope. Accordingly, the scope of the present invention is described by the appended claims and is supported by the foregoing description.

What is claimed is:

1. A method for delivering data over a television signal spectrum, comprising:
receiving information and transmitting the data to a wide network delivery system;
transmitting the data to at least one receiver associated with an edge server;
transferring the data to the edge server, storing the data in a storage element associated with the edge server; and provisioning the data stored in the edge server to a signal combiner;
inserting a signal related to the data into the television signal spectrum, and broadcasting the television spectrum containing the inserted signal; and
receiving the television signal spectrum containing the inserted signal at a receiver device, extracting the data from the received television signal spectrum, and storing the extracted data.

2. The method of claim 1, wherein
the wide network delivery system comprises a satellite; and
a portion of the data is provided with more error protection than specified for a MPEG2 protocol.

3. The method of claim 1, wherein the data is transmitted using a protocol having error correction codes at three different layers.

4. The method of claim 3, wherein one of the three different layers includes a forward error correction code; another of the three different layers includes a cyclic redundancy check code; and the third layer includes an embedded forward error correction code.

5. The method of claim 1, wherein
the inserting of the signal related to the data into the television signal spectrum comprises multiplexing the signal with a conventional analog television signal.

6. The method of claim 1, wherein
the inserting of the signal related to the data into the television signal spectrum comprises multiplexing the signal with a conventional digital television signal.

7. The method of claim 1, wherein the receiving device communicates with a network server via a back channel, said network server being associated with a network center responsible for the transmitting of the data to the wide network delivery system.

8. The method of claim 7, wherein the network center provides for an archiving function.

9. The method of claim 7, wherein the receiving device communicates a receipt of a bad block to the network server via the back channel, and the network server causes a transmission of a data block to replace the bad block received by the receiver device.

10. The method of claim 7, wherein the back channel comprises the Internet.

11. The method of claim 1, wherein the provisioning of the data to the signal combiner is in response to a request from the network center to the edge server via a back channel.

12. The method of claim 1, wherein the receiving the data further comprises:
aggregating a plurality of data elements into the data; and
scheduling the data elements for a release into a local market at a specified release time.

13. The method of claim 12, wherein the provisioning of the data to the signal combiner is in response to the specified release time.

14. The method of claim 1, wherein the extracted data stored in the receiver device is replaced with new data after a period of default time.

15. The method of claim 14, wherein the period of default time is changed in response to a customer's request.

16. The method of claim 14, wherein the extracted data is made transferable to a storage device in response to a customer's request.

17. The method of claim 1, wherein the receiving device communicates with a wired device via a home network.

18. The method of claim 1, wherein the receiving device communicates with a wireless device via a home network.

19. A method for delivering a content element over a television signal spectrum, comprising:
receiving data and transmitting the content element to a wide network delivery system;
transmitting the content element to a receiver associated with an edge server;
transferring the content element to the edge server, storing the content element in a storage element associated with the edge server, and creating an accumulated content element, said accumulated content element being a plurality of content elements received and stored at the edge server over a period of time;
provisioning the accumulated content element to a signal combiner;
inserting a signal related to the accumulated content element into the television signal spectrum and broadcasting the television spectrum containing the inserted signal; and
receiving the television signal spectrum containing the inserted signal at a receiver device, extracting the accumulated content element from the received television signal spectrum, and storing the extracted accumulated content element.

20. The method of claim 19, wherein each content element comprising the accumulated content element is associated with a timestamp, and a new content element replaces the content element associated with the oldest timestamp among the content elements comprising the accumulated content element.

21. The method of claim 19, wherein the edge server receives a new content element and replaces a portion of the accumulated content element with the new content element, using a mark indicated on the portion by a component comprising a network center.

22. The method of claim 21, wherein the network center provides for an archiving function.

23. The method of claim 19, wherein the content element is transmitted using a protocol having error correction codes at three different layers.

24. The method of claim 23, wherein one of the three different layers includes a forward error correction code; another of the three different layers includes a cyclic redundancy check code; and the third layer includes an embedded forward error correction code.

25. The method of claim 19, wherein a portion of the accumulated content element becomes unavailable to a customer in response to a request transmitted by a network center to the edge server via a back channel.

26. The method of claim 19, wherein each content element comprising the extracted accumulated content element at the receiving device is associated with a timestamp; and
the content element associated with the oldest timestamp among the content elements comprising the extracted accumulated content element at the receiving device is replaced with a new content element.

27. The method of claim 19, wherein a portion of the extracted accumulated content element becomes unavailable to a customer in response to a mark indicated on the portion by a component comprising a network center.

28. The method of claim 19, wherein a portion of the extracted accumulated content element becomes unavailable in response to a request transmitted by a network center to the receiving device via a back channel.

29. The method of claim 19, wherein a portion of the extracted accumulated content element is made transferable to a storage element in response to a customer's request.

30. The method of claim 19, wherein the wide network delivery system comprises a satellite.

31. The method of claim 19, wherein the receiving device comprises a communication port for communicating via the Internet with a network center responsible for the transmitting of the content element to the satellite.

32. The method of claim 19, wherein the receiving device comprises a communication port for transferring home information via a home network.

33. The method of claim 19, wherein the receiving device communicates with a wired device via a home network.

34. The method of claim 19, wherein the receiving device communicates with a wireless device via a home network.

35. A method for delivering a plurality of content elements over a plurality of television signal spectrums, comprising:
receiving data and transmitting the plurality of content elements to a wide network delivery system;
transferring the plurality of content elements to a plurality of edge servers located in a local market, each of said edge servers corresponding to at least single content element;
each edge server storing its corresponding content element, causing an insertion of its corresponding content element into its corresponding television signal spectrum;
broadcasting the plurality of television signal spectrums, each spectrum containing the inserted signal related to its corresponding content element; and
receiving the plurality of television signal spectrums, each spectrum containing the inserted signal related to its corresponding content element, extracting a plurality of received content elements from the plurality of the plurality of television signal spectrums, and storing a plurality of extracted received content elements.

36. The method of claim 35, wherein a network center for the transmitting of the plurality of content elements to the wide network delivery system communicates via a back channel with a receiving device for the receiving of the plurality of television signal spectrums.

37. The method of claim 36, wherein the network center provides for an archiving function.

38. The method of claim 35, wherein each of the plurality of content elements is transmitted using a protocol having error correction codes at three different layers.

39. The method of claim 38, wherein one of the three different layers includes a forward error correction code; another of the three different layers includes a cyclic redundancy check code; and the third layer includes an embedded forward error correction code.

40. The method of claim 36, wherein the receiving device communicates a receipt of a bad block to the network center via the back channel, and the network center causes a transmission of a data block to replace the bad block received by the receiver device.

41. The method of claim 36, wherein the receiving device transfers home information via a home network.

42. The method of claim 35, wherein the causing the insertion of its corresponding content element into its corresponding television signal spectrum at each edge server is in response to a request from the network center to the edge server via a back channel.

43. The method of claim 35, wherein each edge server is associated with a signal combiner, and the causing the insertion of its corresponding content element into its corresponding television signal spectrum comprises provisioning the content element to the signal combiner, wherein the signal combiner multiplexes the signal related to the content element and a television signal.

44. The method of claim 35, wherein the wide network delivery system comprises a satellite.

45. The method of claim 36, wherein the back channel comprises the Internet.

46. A system for delivering data over a television signal spectrum, comprising:
a network center for receiving information and transmitting the data to a wide network delivery system;
the wide network delivery system for receiving the data from the network center and forwarding the data to a receiver associated with an edge server;
the edge server for storing the data received by the receiver from the wide network delivery system and for causing an insertion of a signal related to the data into a television signal spectrum;
a transmission facility for transmitting the television signal spectrum containing the inserted signal; and
a receiving device for receiving the television signal spectrum containing the inserted signal, extracting the data from the received television signal spectrum, and storing the extracted data.

47. The system of claim 46, wherein the receiving device comprises a communication port for communicating with the network center.

48. The system of claim 46, wherein the network center provides for an archiving function.

49. The system of claim 46, wherein the data is transmitted using a protocol having error correction codes at three different layers.

50. The system of claim 49, wherein one of the three different layers includes a forward error correction code; another of the three different layers includes a cyclic redundancy check code; and the third layer includes an embedded forward error correction code.

51. The system of claim 46, wherein the wide network delivery system comprises a satellite.

52. The system of claim 46, wherein the network center communicates via the Internet with the receiving device and the edge server.

53. The system of claim 46, wherein the receiving device comprises a communication port for transferring home information via a home network.

54. The system of claim 46, wherein the extracted data is provided to an information kiosk.

55. The system of claim 46, wherein the extracted data is provided to a television.

56. The system of claim 46, wherein the extracted data is provided to a personal computer.

57. The system of claim 46, wherein the extracted data is provided to a mobile device.

58. The system of claim 46 wherein the extracted data is provided to a storage device.

59. The system of claim 46 wherein the extracted data is provided to a display device.

60. The system of claim 46 wherein the extracted data is provided to an audio device.

61. The system of claim 53, wherein the receiving device communicates with a wired device via the home network.

62. The system of claim 53, wherein the receiving device communicates with a wireless device via the home network.

63. A system for delivering a plurality content elements over a plurality of television signal spectrums, comprising:
a network center for receiving information and transmitting the plurality of content elements to a wide network delivery system;
the wide network delivery system for receiving the plurality of data from the network center and forwarding the plurality of data to a plurality of local systems associated with a local market, each local system being associated with at least single content element;
each of the local systems comprising a receiver to receive its corresponding content element from the wide network delivery system, an edge server for storing its corresponding content element and for causing an insertion of the corresponding content element into a television signal spectrum associated with its corresponding local system, and a transmission facility for transmitting the television signal spectrum inserted with a signal related to the corresponding content element; and
a receiving device for receiving the plurality of television signal spectrums, each spectrum containing its corresponding inserted signal, extracting a plurality of received content elements from the plurality of received television signal spectrums, and storing a plurality of extracted and received content elements.

64. The system of claim 63, wherein the receiving device communicates with the network center via a back channel.

65. The system of claim 63, wherein the network center provides for an archiving function.

66. The system of claim 63, wherein each of the plurality of content elements is transmitted using a protocol having error correction codes at three different layers.

67. The system of claim 66, wherein one of the three different layers includes a forward error correction code; another of the three different layers includes a cyclic redundancy check code; and the third layer includes an embedded forward error correction code.

68. The system of claim 63, wherein the receiving device communicates a receipt of a bad block to the network center via the back channel.

69. The system of claim 63, wherein the insertion of the corresponding content element into the television signal spectrum associated with its corresponding local system at each edge server is in response to a request from the network center to the edge server via a back channel.

70. The system of claim 63, wherein the wide network delivery system comprises a satellite.

71. The system of claim 63, wherein each edge server is associated with to a signal combiner, and the causing the insertion of its corresponding content element into its corresponding television signal spectrum comprises provisioning the content element to the signal combiner, wherein the signal combiner multiplexes the signal related to the content element and a television signal.

72. The system of claim 63, wherein the network center communicates via the Internet with the receiving device and each edge server associated with the plurality of local systems.

73. The system of claim 63, wherein the receiving device communicates with a wired device via a home network.

74. The system of claim 63, wherein the receiving device communicates with a wireless device via a home network.

75. A method for delivering data over a television signal spectrum, comprising:
receiving information and transmitting the data to a wide network delivery system;
transferring the data to a server;
storing the data in a storage element associated with the server, inserting a signal related to the data into the television signal spectrum, and broadcasting the television signal spectrum containing the inserted signal;
receiving the television signal spectrum containing the inserted signal, extracting the data from the television signal spectrum containing the inserted signal, and storing the extracted data; and
receiving information regarding the extracted data via a back channel.

76. The method of claim 75, wherein the wide network delivery system comprises a satellite.

77. The method of claim 75, wherein the receiving and transmitting the data to a wide network delivery system is provided by a network center.

78. The method of claim 77, wherein the network center provides an archiving function.

79. The method of claim 75, wherein the data is transmitted using a protocol having error correction codes at three different layers.

80. The method of claim 79, wherein one of the three different layers includes a forward error correction code; another of the three different layers includes a cyclic redundancy check code; and the third layer includes an embedded forward error correction code.

81. The method of claim 75, wherein the back channel comprises the Internet.

82. The method of claim 75, wherein the receiving device communicates with a wired device via a home network.

83. The method of claim 75, wherein the receiving device communicates with a wireless device via a home network.
